(19) United States
(12) Patent Application Publication
(10) Pub. No.: US 2010/0219234 A1
(43) Pub. Date: Sep. 2, 2010

(54) Mobile ticket authentication

(75) Inventor: Ronald Forbes, Penicuik (GB)

Correspondence Address: EDWARDS ANGELL PALMER & DODGE LLP, P.O. BOX 55874, BOSTON, MA, 02205, US

(73) Assignee: Mobiqa Limited, Edinburgh (GB)

(21) Appl. No.: 11/919,194

(22) PCT Filed: Apr. 25, 2006
(86) PCT No.: PCT/GB2006/001512

§ 371 Date: May 17, 2010

Related U.S. Application Data
(60) Provisional application No. 60/674,534, filed on Apr. 25, 2005.

(51) Int. Cl. G06F 17/00; H04W 4/00

(52) U.S. Cl. 235/375; 455/414.1

(57) ABSTRACT

The method and system provide convenient and efficient authentication of mobile tickets (46). A ticket purchaser provides a photo image (40) of himself or herself that is stored with the purchaser's phone number and a ticket identifier in a database (32). A mobile ticket (46) is generated comprising the ticket identifier as a barcode and the photo. The ticket is transmitted to the purchaser's mobile phone (38). The ticket is authenticated by reading the ticket identifier from the phone (38) into a terminal (54), for example by barcode scanning (52) of the phone's screen (50). The identifier is used to look up (56) the stored image (58) which is displayed on the screen of the terminal (60). The operator of the terminal can then compare the photo on the terminal (60) with the actual purchaser and the photo on the display of the phone (50) in order to authenticate the ticket (46) as belonging to the purchaser.

The present invention relates to the authentication of tickets and in particular to a system and method of and authenticating mobile tickets using images.

Ticket scalping or touting and forgery is a significant problem for promoters of events and ticket agents. Tickets for major events often sell out almost immediately, but are still available at greatly inflated prices, for example, on websites. This is also a problem for consumers who wish to pay a fair price for tickets.

In order to prevent the transfer of paper tickets and their sale on the secondary market, a number of techniques have been applied to ensure that the ticket is used by the original purchaser. These include providing a utility bill, photo ID, such as a passport, or the credit or debit card that was made to make the original purchase. All of these techniques have had limited success and make the manual inspection of the ticket even more difficult. Ticket touts even blatantly offer forged ID along with the ticket.

In the case of membership cards they are often passed around a number of people. This means that a club can lose membership revenue and there is also a security threat in this situation.

The distribution of tickets directly to mobile phones as messages including barcodes has been found to be a convenient way to distribute tickets and are easy for a user to retain, retrieve and present on redemption. The incorporation of a barcode in such an electronic ticket further aids redemption because a barcode scanner can be used. However such mobile tickets still suffer from the problems identified above in relation to paper tickets.

A further recent development is the integration of digital cameras in mobile telephones which provide a convenient way for the user to capture images of themselves.

It is an object of the present invention to provide convenient and efficient authentication of mobile tickets that overcomes at least some of the problems of the prior art.

According to a first aspect of the present invention there is provided method of authenticating a ticket, the method comprising the steps:
generating a first ticket identifier;
receiving a first mobile device identifier
associated with a mobile device;
receiving an image;
storing the first ticket identifier, the first mobile device identifier and the image in the database so as to be related to each other;
generating the ticket comprising the first ticket identifier;
transmitting the ticket to a mobile device;
receiving at a terminal an input of a second ticket identifier; and
matching the first and second ticket identifiers so as to retrieve the image from the database; and
displaying the image on a display of the terminal.

Preferably, the step of receiving an image comprises the steps of:
receiving a first message comprising the image;
receiving a second mobile device identifier identified with the first message; and
matching the first and second mobile device identifiers so as to retrieve the first ticket identifier.

Preferably, the method further comprises the step of extracting the image from the first message.

Preferably, the method further comprises the step, prior to transmitting the ticket, of optimising the ticket for the mobile device.

Preferably, the method further comprises the step, after transmitting the ticket, of outputting the first ticket identifier from the mobile device.

Preferably, the step of outputting comprises the step of displaying the first ticket identifier on the display of the mobile device.

Preferably, the ticket further comprises the image and the step of displaying the first ticket identifier on the display of the mobile device further comprises the step of displaying the image on the display of the mobile device.

Preferably, the first ticket identifier comprises a barcode.

Preferably, the step of receiving at the terminal an input comprises scanning the display of the mobile device.

According to a second aspect of the present invention there is provided a ticket authentication system comprising:
a ticket identifier generating module adapted to generate a first ticket identifier;
a receiving module adapted to receive a first mobile device identifier associated with a mobile device and adapted to receive an image;
a database adapted to store the first ticket identifier, the first mobile device identifier and the image so as to be related to each other;
a ticket generating module adapted to generate a ticket comprising the first ticket identifier;
a sending module adapted to transmit the ticket to the mobile device;
a terminal adapted to receive an input of a second ticket identifier; and
a query module adapted to retrieve the image from the database by matching the first and second ticket identifiers,
wherein the terminal is further adapted to display the retrieved image.

Preferably, the system further comprises an image receiving module adapted to:
receive a first message comprising the image;
receive a second mobile device identifier identified with the first message; and
match the first and second mobile device identifiers so as to retrieve the first ticket identifier.

Preferably, the image receiving module is further adapted to extract the image from the first message.

Preferably, the system further comprises an optimising module adapted to optimise the ticket for the mobile device.

Preferably, the system further comprises the mobile device, wherein the mobile device is adapted to output the first ticket identifier.

Preferably, the mobile device is adapted to output the first ticket identifier by displaying it on a display of the mobile device.

Preferably, the ticket further comprises the image and the mobile device is further adapted to display the image on the display of the mobile device.

Preferably, the first ticket identifier comprises a barcode.

Preferably, the system further comprises a scanner adapted to scan the display of the mobile device thereby receiving a second ticket identifier, and the scanner is further adapted to transmit the second ticket identifier to the terminal and the terminal is adapted to receive the input of the second ticket identifier from the scanner.

According to a third aspect of the present invention there is provided at least one computer program comprising program instructions for causing at least one computer to perform the method according to the first aspect.

Preferably, the at least one computer program is embodied on a recording medium or read-only memory, stored in at least one computer memory, or carried on an electrical carrier signal.

According to a fourth aspect of the present invention there is provided a computer program comprising program instructions, which when loaded into at least one computer, constitutes the ticket identifier generating module, receiving module, ticket generating module, sending module and query module according to the second aspect.

Preferably, the computer program is embodied on a recording medium or read-only memory, stored in at least one computer memory, or carried on an electrical carrier signal.

An embodiment of the present invention is presented by way of example only with reference to the following figures wherein:

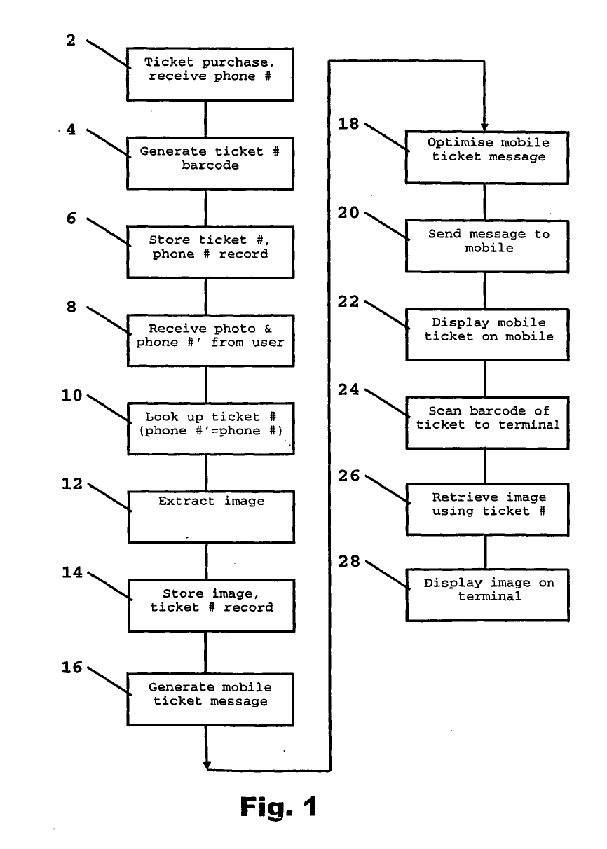

FIG. 1 is a flow chart showing the steps in accordance with an embodiment of the present invention; and

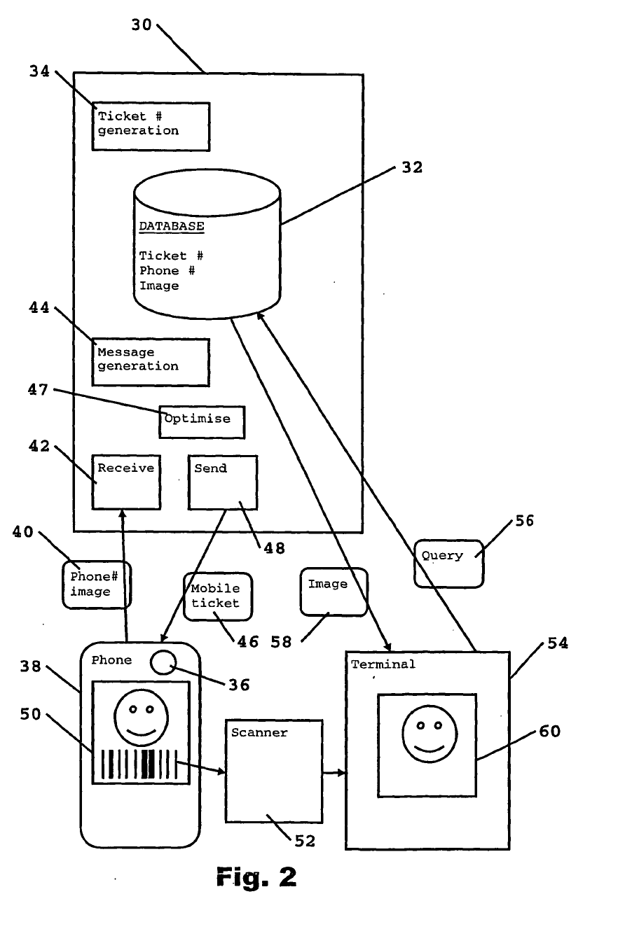

FIG. 2 shows, in schematic form, a system according to an embodiment of the present invention.

This embodiment of the present invention provides a secure mobile ticket or pass containing a pre-registered photograph of the ticket holder together with a unique barcoded ticket to a mobile phone. The authentication of the ticket involves scanning the barcode displayed on the screen of the mobile phone, then retrieving and displaying the pre-registered photograph on a terminal for inspection and comparison with the ticket holder and the mobile ticket displayed on the screen of the mobile phone.

With reference to FIGS. 1 and 2 the registration 2 for a ticket may be through purchase of a ticket through a box office or a web site. The payment is made in the normal way using a credit or debit card. For a membership pass the customer can complete the membership form and make the annual membership payment. The ticket or pass will not however be issued immediately but at registration the customer provides their mobile phone number (or email address) in order to identify themselves.

The ticket details including the ticket number, event, date, start time, seat number etc. are generated 4. The ticket details and the mobile phone number (or email address) are stored 6 at an authentication centre 30 in a database 32 so as to be related to each other.

The database 32 stores the following ticket details although additional ticket information could also be held: event, date, start time, ticket number (barcode), seat number (optional), mobile phone number, email address (optional), name, photograph.

In another embodiment the customer's photograph is submitted along with the phone number (or email address) at the point of registration 2, however in this embodiment in order to activate and receive the ticket or pass, the customer supplies the photograph in a separate step. This is done using their camera 36 on their mobile phone 38 by taking a photograph of the customer and sending this as an MMS (multi-media messaging service) message 40 to the ticket agent's number or shortcode. This message is subsequently received 8 at the authentication centre's image receiving module 42 and the customer's mobile number (or email address) is captured automatically.

The mobile phone number of the message is matched against stored phone numbers in the database in order to look up 10 the ticket number previously associated with the mobile phone number. This ensures that only the original intended recipient can receive the ticket. The photograph is extracted 12 and stored 14 in the ticket database associated with the ticket number and mobile phone number.

Alternatively the photograph can be sent via email in order to activate and receive the ticket or pass and the sender's email address is matched against the email address provided at the registration step. Another alternative is to upload the photograph from the ticket sales web site where it has previously been stored.

The mobile ticket 46 is generated 16, by a message generating module 44, as a message 46 by merging the photograph with a unique barcoded ticket number. The ticket identifier is typically rendered as a barcode image. The message is optimised 18 by an optimising module 47 (according to the teaching of WO2004/027662 by the present inventor) for the display of the mobile phone and the messaging protocol that is being employed.

The mobile ticket is then sent 20 from the sending module 48 of the authentication centre, to the mobile phone. The mobile ticket contains the photograph, the barcode and the ticket text. The barcode may be overlaid on the photograph of the customer. Additional media including further images, video etc. may also be included in the message.

As an alternative to MMS, other mobile photo multi-media messaging technologies including WAP can be used to deliver the ticket. Instead of a mobile phone other mobile devices, e.g. a PDA (Personal Digital Assistant) may be used.

In the case that the ticket is provided to the mobile phone by email, it is not necessary that the mobile phone is MMS enabled.

As a compromise, a barcoded mobile ticket can be delivered to the mobile phone over SMS without the photograph.

The ticket is used by the customer by displaying 22 the mobile ticket on the display 50 of the mobile phone. The member of staff at the door or access point at the venue of the event scans 24 the barcode on the mobile display using a hand-held scanner 52 into a terminal 54. Thus in this embodiment, the ticket identifier is output from the mobile phone as a barcode on the phone's display. In other embodiments the ticket identifier may be output from the phone in other ways, such as using radio signals, e.g. Bluetooth or WiFi. Such output may be received by the terminal, for example using a radio receiver. The terminal may be a PC (Personal Computer) or a PDA. The image is retrieved 26 from the database by the terminal transmitting a query 56 to the authentication centre thereby matching the unique ticket number from the scanned barcode against the stored ticket numbers in the database. The related previously supplied photograph is retrieved from the database, transmitted 58 to the terminal and displayed 28 on the display 60 of the terminal. The operator of the terminal then checks the photograph on the terminal display against that on the mobile phone display (if present on the mobile phone) and the face of the person presenting the ticket. Thus the operator can conveniently view the authenticated photograph of the ticket holder on their terminal and compare that to the ticket holder. Furthermore if the mobile ticket displayed on the display of the mobile phone contains the photograph then the operator can also conveniently compare that photograph with the one on their terminal and the ticket holder.

Improvements and modifications may be incorporated herein without deviating from the scope of the invention.

1. A method of authenticating a ticket, the method comprising the steps:
generating a first ticket identifier;
receiving a first mobile device identifier associated with a mobile device;
receiving an image;
storing the first ticket identifier, the first mobile device identifier and the image in the database so as to be related to each other;
generating the ticket comprising the first ticket identifier;
transmitting the ticket to a mobile device;
receiving at a terminal an input of a second ticket identifier; and
matching the first and second ticket identifiers so as to retrieve the image from the database; and
displaying the image on a display of the terminal.

2. The method of claim 1, wherein the step of receiving an image comprises the steps of:
receiving a first message comprising the image;
receiving a second mobile device identifier identified with the first message; and
matching the first and second mobile device identifiers so as to retrieve the first ticket identifier.

3. The method of claim 2 further comprising the step of extracting the image from the first message.

4. The method of any previous claim, further comprising the step, prior to transmitting the ticket, of optimising the ticket for the mobile device.

5. The method of any previous claim, further comprising the step, after transmitting the ticket, of outputting the first ticket identifier from the mobile device.

6. The method of claim 5, wherein the step of outputting comprises the step of displaying the first ticket identifier on the display of the mobile device.

7. The method of claim 6, wherein the ticket further comprises the image and the step of displaying the first ticket identifier on the display of the mobile device further comprises the step of displaying the image on the display of the mobile device.

8. The method of any previous claim, wherein the first ticket identifier comprises a barcode.

9. The method of any of claims 6 to 8, wherein the step of receiving at the terminal an input comprises scanning the display of the mobile device.

10. A ticket authentication system comprising:
a ticket identifier generating module adapted to generate a first ticket identifier;
a receiving module adapted to receive a first mobile device identifier associated with a mobile device and adapted to receive an image;
a database adapted to store the first ticket identifier, the first mobile device identifier and the image so as to be related to each other;
a ticket generating module adapted to generate a ticket comprising the first ticket identifier;
a sending module adapted to transmit the ticket to the mobile device;
a terminal adapted to receive an input of a second ticket identifier; and
a query module adapted to retrieve the image from the database by matching the first and second ticket identifiers,
wherein the terminal is further adapted to display the retrieved image.

11. The system of claim 10, further comprising an image receiving module adapted to:
receive a first message comprising the image;
receive a second mobile device identifier identified with the first message; and
match the first and second mobile device identifiers so as to retrieve the first ticket identifier.

12. The system of claim 11, wherein the image receiving module is further adapted to extract the image from the first message.

13. The system of any of claims 10 to 12, further comprising an optimising module adapted to optimise the ticket for the mobile device.

14. The system of any of claims 10 to 13, further comprising the mobile device, wherein the mobile device is adapted to output the first ticket identifier.

15. The system of claim 14, wherein the mobile device is adapted to output the first ticket identifier by displaying it on a display of the mobile device.

16. The system of claim 15, wherein the ticket further comprises the image and the mobile device is further adapted to display the image on the display of the mobile device.

17. The system of any of claims 10 to 16, wherein the first ticket identifier comprises a barcode.

18. The system of any of claims 10 to 17 further comprising a scanner adapted to scan the display of the mobile device thereby receiving a second ticket identifier, and the scanner is further adapted to transmit the second ticket identifier to the terminal and the terminal is adapted to receive the input of the second ticket identifier from the scanner.

19. At least one computer program comprising program instructions for causing at least one computer to perform the method according to claims 1 to 9.

20. The at least one computer program of claim 19, wherein the at least one computer program is embodied on a recording medium or read-only memory, stored in at least one computer memory, or carried on an electrical carrier signal.

21. A computer program comprising program instructions, which when loaded into at least one computer, constitutes the ticket identifier generating module, receiving module, ticket generating module, sending module and query module of any of claims 10 to 18.

22. The computer program of claim 21, wherein the computer program is embodied on a recording medium or read-only memory, stored in at least one computer memory, or carried on an electrical carrier signal.
